(19) United States
(12) Patent Application Publication
(10) Pub. No.: US 2020/0097350 A1
(43) Pub. Date: Mar. 26, 2020

(54) VISUAL TIMELINE BASED SYSTEM TO RECOMMEND POTENTIAL ROOT CAUSE OF FAILURE AND REMEDIATION OF AN OPERATION USING CHANGE MANAGEMENT DATABASE

(71) Applicant: CA, Inc., New York, NY (US)

(72) Inventors: Vallinayagam Pitchaimani, Chennai (IN); Praveen Chavali, Hyderabad (IN); Sunil Meher, Hyderabad (IN); Siva Datla, Hyderabad (IN)

(73) Assignee: CA, Inc., New York, NY (US)

(21) Appl. No.: 16/140,725

(22) Filed: Sep. 25, 2018

(51) Int. Cl. G06F 11/07; G06F 11/22; G06F 11/263; G06F 17/30

(52) U.S. Cl. CPC G06F 11/079; G06F 11/2273; G06F 17/30002; G06F 17/30958; G06F 11/2635

(57) ABSTRACT

A method and computing system to recommend potential root causes of failure of an operation of a computer system is provided. An indication of a failed operation is received. A number of change orders (CO) that change one or more configuration items (CIs) that are associated with the operation from a baseline state to the current state of operation is determined. A root cause analysis (RCA) graph is displayed for a selected CO and has a plurality of CIs and connections therebetween in a first display area and a change order timeline in a second display area. Any of the number of CIs that were changed are highlighted. A potential cause listing in a third display area provides a list of highlighted CIs and a percentage indication by each highlighted CI that represents a calculated percentage that the CI is a potential cause of the failed operation.

### FIELD

Some embodiments described herein relate to root cause analysis, and in particular, to recommending potential root causes of failure using a visual timeline.

### BACKGROUND

When a failure of an operation such as a component or an input connection occurs in a computing system, typically a change management database (CMDB) is used to find the root cause and do impact analysis of the infrastructure affected by the operation failure. The CMDB is used to store configuration items (i.e., components, connections, services, etc.) and their relationships such as connections between the configuration items.

Often, change orders are used to document changes to the configuration items and connections between the configuration items. These changes are typically versioned for purposes such as auditing and tracking. Over a period of time, there can be numerous changes to a configuration item with multiple change orders directly and indirectly associated with the configuration item.

When finding the root cause of failure of an operation in a CMDB system, the current state of the configuration items are used. Correlating the configuration item's versioning (i.e., change history) in conjunction with the current state is tedious and error prone, especially when there are multiple change orders directly and indirectly associated with the configuration item.

### SUMMARY

Some embodiments are directed to a method by a computer of a computing system for providing one or more root cause analysis (RCA) graphs associated with a root cause of failure. The method includes receiving an indication of an operation that failed in a computer system associated with the operation. Starting at a baseline state of the operation and ending at a current state of the operation, a number of change orders that change one or more configuration items that are associated with the operation are determined. A baseline state root cause analysis (RCA) graph is displayed. The baseline state RCA graph represents a last known state of the operation where the operation passed testing. The baseline state RCA graph has a plurality of configuration items and connections between the plurality of configuration items in a first area of a display and a change order timeline in a second area of the display. For each of the number of change orders and responsive to receiving a user selection of a change order in the change order timeline, a RCA graph of a state of the computer system associated with the operation is displayed. The RCA graph of the state of the computer system associated with the operation has a number of the plurality of configuration items that remain associated with the operation and connections between the number of the plurality of configuration items displayed in the first area. Any of the number of the plurality of configuration items that remain that were changed by the change order are highlighted. The RCA graph also has an indication of the change order displayed in the change order timeline, and a potential cause listing in a third area of the display. The potential cause listing displays a list of configuration items that are highlighted and a percentage indication by each configuration item in the list of configuration items. Each percentage indication represents a calculated percentage that the configuration item is a potential cause of the failure.

The method may further include displaying a number of new configuration items added by the change order in the first area and connections between the number of new configuration items and the number of the plurality of configuration items displayed in the first area and highlighting any of the number of new configuration items that were changed by the change order.

The RCA graph of the state of the computer system associated with the operation may further include a suggestion action displayed in a fourth area of the display responsive to a percentage indication of a configuration item listed in the third area of the display being above a first threshold level.

The method may further include responsive to a highest calculated percentage being below a second threshold level, displaying on a currently displayed RCA graph a suggestion that a higher number of configuration item levels should be displayed. The method, for each RCA graph, displays the number of configuration item levels when the RCA graph is being displayed responsive to receiving an indication of a number of configuration item levels to display.

Corresponding configuration management system configured to recommend potential root causes of failure of an operation of a computer system are disclosed. In some embodiments, the configuration management system includes an incident problem management engine configured to receive a message indicating an operation that failed in the computer system. The configuration management system further includes a configuration management database (CMDB) configured to receive and store change orders; store associations of configuration items with change orders and operations of computer systems; and store information regarding a baseline state for a plurality of operations performed by the computer system, each baseline state representing a last known state of an operation of the plurality of operations in which the operation passed testing, the information for each baseline state comprising a listing of a plurality of configuration items and connections between the plurality of configuration items. The configuration management system further includes a change management engine is configured to responsive to receiving an indication of the message indicating the operation that failed, fetch information from the CMDB regarding a baseline state for the operation that failed. The change management is further configured to identify, from the CMDB and starting at a baseline state of the operation and ending at a current state of the operation, a number of change orders that change one or more configuration items that are associated with the operation. The change management is further configured to, for each of the number of change orders, fetch information from the CMDB regarding configuration items changed by the change order. The change management is further configured to display a baseline state root cause analysis (RCA) graph in a first area of a display and a change order timeline in a second area of the display. The change management is further configured to responsive to receiving a user selection of a change order in the timeline, display a RCA graph of a state of the computer system associated with the operation, wherein the RCA graph of the state of the computer system associated with the operation includes: a number of the plurality of configuration items that remain associated with the operation and connections between the number of the plurality of configuration items displayed in the first area, wherein any of the number of the plurality of configuration items that remain that were changed by the change order are highlighted; a number of new configuration items when the change order indicates new configuration items have been added and connections between the number of new configuration items and the number of the plurality of configuration items displayed in the first area, wherein any of the number of new configuration items that were added by the change order are highlighted; an indication of the change order displayed in the change order timeline; and a potential cause listing in a third area of the display, wherein the potential cause listing displays a list of configuration items that are highlighted and a percentage indication by each configuration item in the list of configuration items, each percentage indication representing a calculated percentage that the configuration item is a potential cause of the failure.

The CMDB may further be configured to receive a new change order, parse the change order to determine configuration items changed by the new change order and to determine configuration items added or deleted from the computer system, and store information regarding the configuration items changed by the new change order and information regarding the configuration items added or deleted from the computer system.

The configuration management engine may further be configured to responsive to a highest calculated percentage being below a second threshold level, display on a currently displayed RCA graph a suggestion that a higher number of configuration item levels should be displayed; and responsive to receiving an indication of a number of configuration item levels to display, for each RCA graph, displaying the number of configuration item levels in the RCA graph being displayed.

It is noted that aspects of the inventive concepts described with respect to one embodiment may be incorporated in different embodiments although not specifically described relative thereto. That is, all embodiments or features of any embodiments can be combined in any way and/or combination. These and other objects or aspects of the present inventive concepts are explained in detail in the specification set forth below.

Advantages that may be provided by various of the concepts disclosed herein include reducing occurrence of errors in determining a root cause of failure of an operation, reducing load on the networks used by: displaying changes made by a change order and a percentage indication that the configuration items changed are the root cause of failure; and providing an indication that a higher percentage possible root cause of failure is in another RAC graph of another change order.

Other methods, devices, and computer program products, and advantages will be or become apparent to one with skill in the art upon review of the following drawings and detailed description. It is intended that all such additional systems, methods, or computer program products and advantages be included within this description, be within the scope of the present inventive concepts, and be protected by the accompanying claims.

### BRIEF DESCRIPTION OF THE DRAWINGS

The accompanying drawings are included to provide a further understanding of the disclosure and are incorporated in and constitute a part of this application. In the drawings:

FIG. 1 is a block diagram illustrating an example of an environment of a configuration management system center according to some embodiments.

FIGS. 2A and 2B are exemplary signaling diagrams for illustrating procedures according to an embodiment.

FIG. 3 is an illustration of a baseline state root cause analysis (RCA) graph and an illustration of configuration levels according to an embodiment.

FIG. 4 is an illustration of a root cause analysis (RCA) graph associated with a change order according to some embodiments.

FIG. 5 is an illustration of a root cause analysis (RCA) graph associated with a change order according to some embodiments.

FIG. 6 is an illustration of a current state root cause analysis (RCA) graph according to some embodiments.

FIG. 7 is a flowchart illustrating operations to initiate implementation of a suggestion action according to some embodiments.

FIG. 8 is a flowchart illustrating operations to perform a test routine and update an RCA graph according to some embodiments.

FIG. 9 is a flowchart illustrating operations to calculate a calculated percentage according to some embodiments.

FIG. 10 is a flowchart illustrating operations to calculate a calculated percentage according to some embodiments.

FIG. 11 is a flowchart illustrating operations to receive a change in user configurable weights and recalculating the calculated percentage according to some embodiments.

FIG. 12 is a flowchart illustrating operations to display a higher number of configuration items in a currently displayed RCA graph according to some embodiments.

FIG. 13 is a flowchart illustrating operations to parse a new change order and update stored information regarding configuration items changed by the change order according to some embodiments.

FIG. 14 is a flowchart illustrating operations to update information stored in the CMDB to reflect changes in change orders and configuration times affected by the suggestion action according to some embodiments.

FIG. 15 is a flowchart illustrating operations to display another RCA graph according to some embodiments.

FIG. 16 is a block diagram of a change management database according to some embodiments.

FIG. 17 is a block diagram of an incident/problem management engine according to some embodiments.

FIG. 18 is a block diagram of a change management engine according to some embodiments.

### DETAILED DESCRIPTION OF EMBODIMENTS

Embodiments of the present inventive concepts now will be described more fully hereinafter with reference to the accompanying drawings. Throughout the drawings, the same reference numbers are used for similar or corresponding elements. The inventive concepts may, however, be embodied in many different forms and should not be construed as limited to the embodiments set forth herein. Rather, these embodiments are provided so that this disclosure will be thorough and complete, and will fully convey the scope of the inventive concepts to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present inventive concepts.

As used herein, the term “or” is used nonexclusively to include any and all combinations of one or more of the associated listed items.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises,” “comprising,” “includes” or “including” when used herein, specify the presence of stated features, integers, steps, operations, elements, or components, but do not preclude the presence or addition of one or more other features, integers, steps, operations, elements, components, or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments described herein provide methods or change management systems for recommending potential root cause of failure of an operation of a computer system. According to some embodiments, the configuration management system includes an incident problem management engine configured to receive a message indicating an operation that failed in the computer system. The configuration management system further includes a configuration management database (CMDB) configured to receive and store change orders; store associations of configuration items with change orders and operations of computer systems; and store information regarding a baseline state for a plurality of operations performed by the computer system, each baseline state representing a last known state of an operation of the plurality of operations in which the operation passed testing, the information for each baseline state comprising a listing of a plurality of configuration items and connections between the plurality of configuration items. The configuration management system further includes a change management engine is configured to responsive to receiving an indication of the message indicating the operation that failed, fetch information from the CMDB regarding a baseline state for the operation that failed. The change management is further configured to identify, from the CMDB and starting at a baseline state of the operation and ending at a current state of the operation, a number of change orders that change one or more configuration items that are associated with the operation. The change management is further configured to, for each of the number of change orders, fetch information from the CMDB regarding configuration items changed by the change order. The change management is further configured to display a baseline state root cause analysis (RCA) graph in a first area of a display and a change order timeline in a second area of the display. The change management is further configured to responsive to receiving a user selection of a change order in the timeline, display a RCA graph of a state of the computer system associated with the operation, wherein the RCA graph of the state of the computer system associated with the operation includes: a number of the plurality of configuration items that remain associated with the operation and connections between the number of the plurality of configuration items displayed in the first area, wherein any of the number of the plurality of configuration items that remain that were changed by the change order are highlighted; a number of new configuration items when the change order indicates new configuration items have been added and connections between the number of new configuration items and the number of the plurality of configuration items displayed in the first area, wherein any of the number of new configuration items that were added by the change order are highlighted; an indication of the change order displayed in the change order timeline; and a potential cause listing in a third area of the display, wherein the potential cause listing displays a list of configuration items that are highlighted and a percentage indication by each configuration item in the list of configuration items, each percentage indication representing a calculated percentage that the configuration item is a potential cause of the failure.

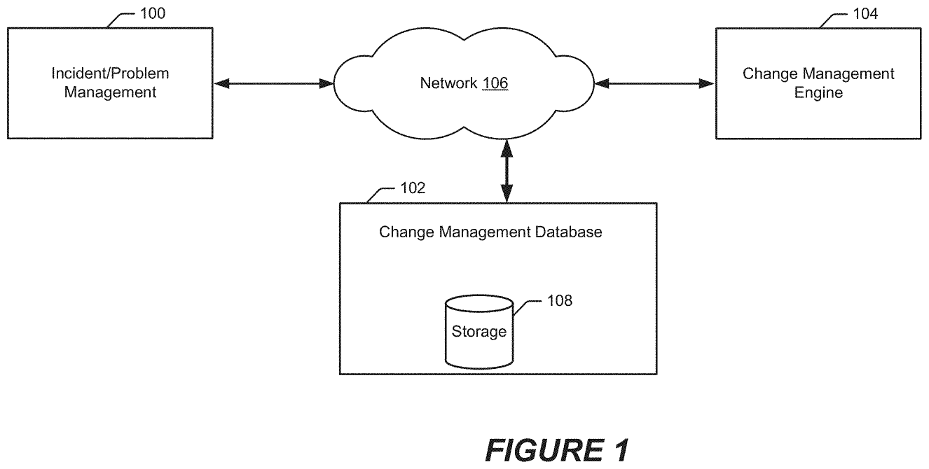

FIG. 1 is a block diagram illustrating an environment for recommending potential root cause of failure of an operation of a computer system according to an embodiment. As shown, an incident/problem management engine 100 communicates with change management database (CMDB) 102 and change management engine 104 via network 106. Network 106 may be a wired network, a wireless network, or a combination of a wired network and a wireless network. While incident/problem management engine 100 and change management engine 104 are shown as separate entities, they may be combined into a single entity or combined with CMDB 102 in other embodiments. CMDB 102 has storage 108 that stores information regarding change orders as explained below.

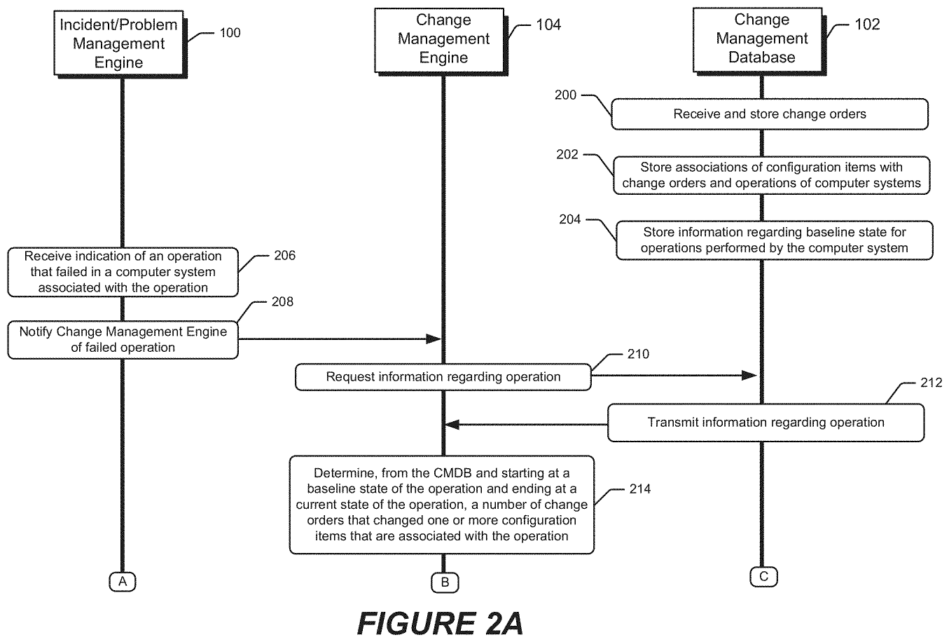

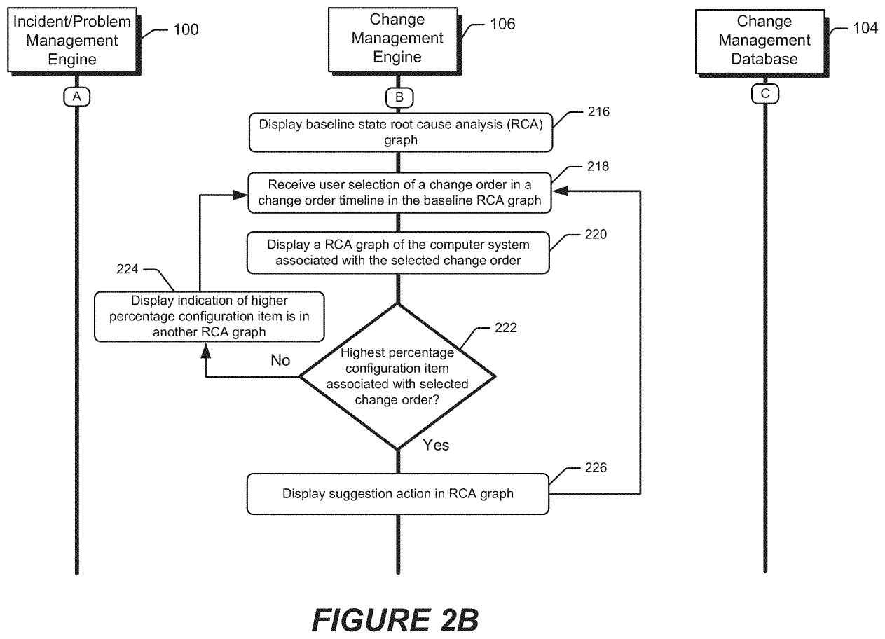

As further described in FIGS. 2A and 2B, the change management engine 104 communicates with incident/problem management engine 100 and CMDB 102. FIGS. 2A and 2B are a signaling diagram of an exemplary procedure that includes reducing occurrence of errors when determining a root cause of failure of an operation. The procedures of FIGS. 2A and 2B involve the incident/problem management engine 100, the CMDB 102 and change management engine 104.

Initially, at operation 200, the CMDB 102 receives and stores change orders for operations of computer systems that the CMDB 102 services. Each change order documents changes in one or more operations of a computer system serviced by the CMDB 102. A change order may document which users or group of users is affected by the change, a classification of the change order, a type of the change order, an indication of who approved the change order, and what configuration items and relationships between configuration items are changed by the change order.

A configuration item may be a service, a device, a device component, software, a software update, a software patch, and the like. A relationship is the logical relation between two configuration items. For example, a computer server that contains a Windows operating system is a relationship. Whenever a configuration item is changed, a change order documents the change. Each change order may be associated with multiple configuration items.

In an embodiment, a classification of a change order specifies whether the change order is a major incident, an unauthorized change order, an emergency order, or none of the preceding classifications (i.e., is not a major incident, an unauthorized change order, or an emergency order). A major incident is defined by the entity controlling the CMDB 102. Each change order requires specified conditions to be met. If these conditions are not met, the change order is an unauthorized change order. When a business decides a change is urgent, the change order is classified as an emergency order.

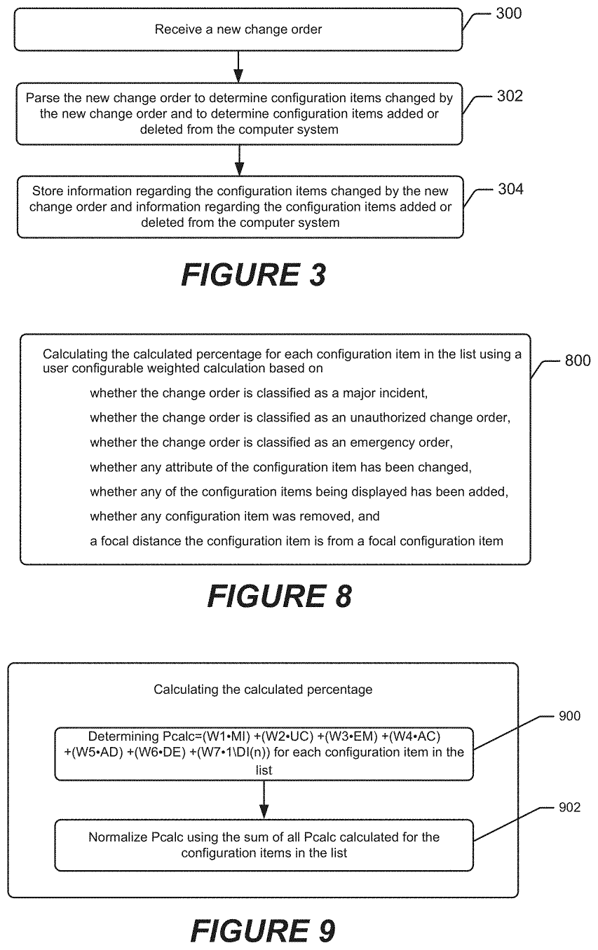

The CMDB 102 performs operations on change orders. Turning to FIG. 3, at operation 300, the CMDB 102 receives a change order such as a new change order. At operation 302, the CMDB 102 parses the change order to determine information including configuration items changed by the change order. For example, a configuration item may be changed, a new configuration item may be added to an operation of a computer system serviced by the CMDB 102, a configuration item may be removed from an operation of a computer system serviced by the CMDB 102, etc. The information is stored in the CMDB storage 108.

Returning to FIG. 2A, at operation 202, the CMDB 102 stores associations of configuration items with change orders and operations of computer systems serviced by the CMDB 102. For example, an operation of a computer system may require multiple configuration items to be connected together or perform the operation. Any change order affecting any of the configuration items required by the operation is also stored as an association with the operation. Thus, when an operation fails, the CMDB 102 can fetch the change orders affecting the operation using the association.

At operation 204, the CMDB 102 stores information regarding a baseline state for operations performed by the computer systems serviced by the CMDB 102. A baseline state is the last known state where the operation was working properly.

At operation 206, the incident/problem management engine 100 receives an indication of an operation that failed in a computer system associated with the operation. The failed operation may be a failure of a service or a failure of a device or a failure of a component of a device. The indication may come from a monitoring system that monitors components and services in the computer system and issues alarms when failures occur, from a built-in-test routine, from a user, from a help-desk, etc. At operation 208, the incident/problem management engine 100 notifies the change management engine 104 of the failed operation.

At operation 210, the change management engine 104 transmits a request to the CMDB 102 for information regarding the failed operation. At operation 212, the CMDB 102 transmits the information requested to the change management engine 102. The information requested includes configuration items associated with the failed operation, change orders associated with the operation or the configuration items associated with the failed operation, and a baseline state of the operation.

At operation 214, the change management engine 104 determines, from the information from the CMDB 102, starting at the baseline state of the failed operation and ending at a current state of the failed operation, a number of change orders that changed one or more of the configuration items that are associated with the operation.

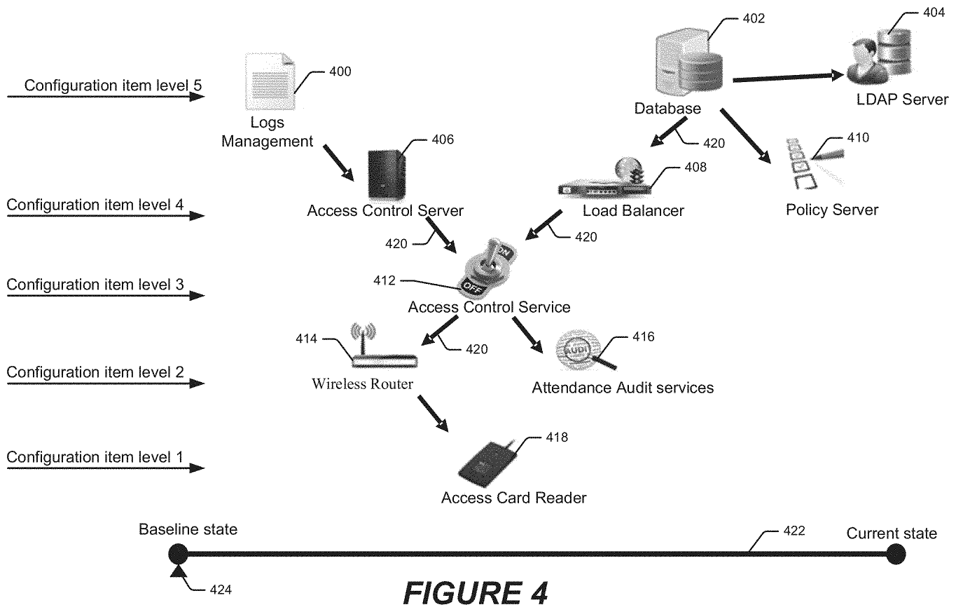

Turning to FIG. 2B, at operation 216, the change management engine 104 displays on a display a baseline root cause analysis (RCA) graph. In the description that follows, a failure in an access control operation shall be used to describe the baseline RCA graph. FIG. 4 illustrates an exemplary baseline state RCA graph for an access control service operation. The baseline state RCA graph has configuration has configuration items 400-418 and connections 420 between configuration items. Five configuration item levels are shown. Configuration item level 5 has three configuration items, specifically logs management 400, database 402, and LDAP server 404. Configuration item level 4 has three configuration items, specifically access control server 406, load balancer 408, and policy server 410. Configuration item level 3 has one configuration item, specifically access control service 412. Configuration item level 2 has two configuration items, specifically wireless router 414 and attendance audit services 416. Configuration item level 1 has one configuration item, specifically access card reader 418. The baseline state graph also has a change order timeline 422 starting at the baseline state of the operation and ending at the current state of the operation. Indicator 424 is used to show where in the change order timeline the RCA graph being displayed is located.

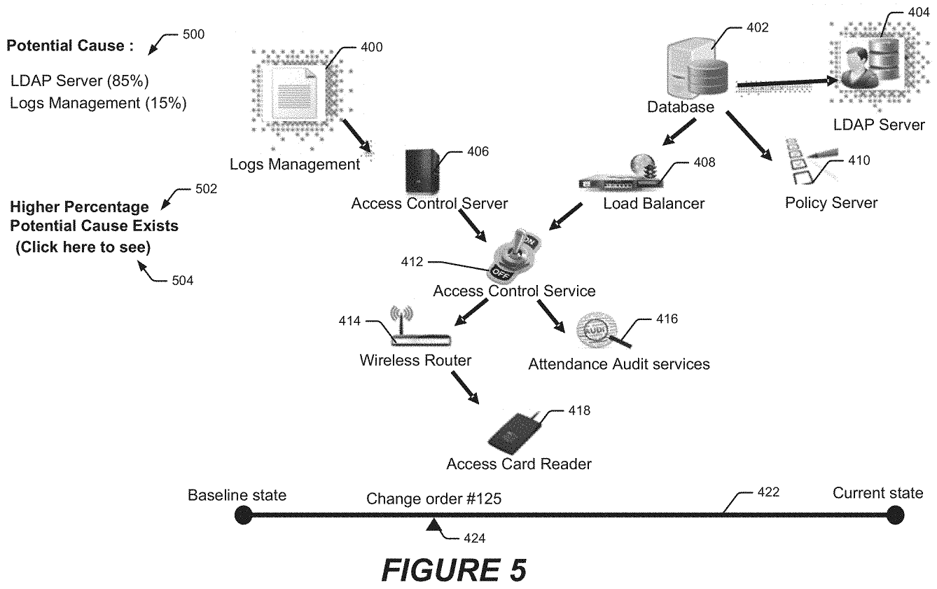

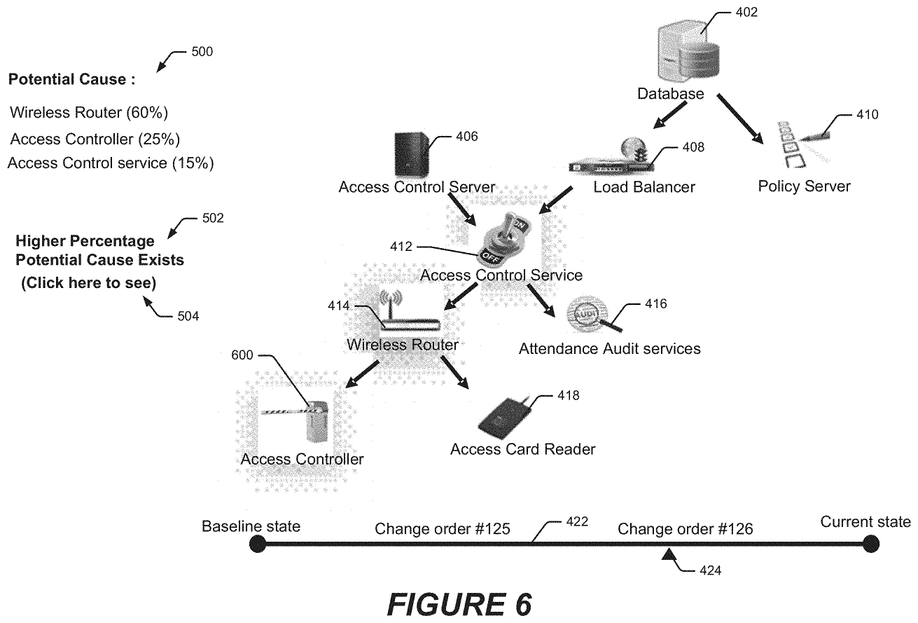

Returning to FIG. 2B, the change management engine 104 receives a user selection of a change order in the change order timeline in the baseline RCA graph. For example, a user may select a point along the change order timeline 422 and the indicator 424 will move to where the user made a selection and the change order associated with the selected point will be displayed. At operation 220, a RCA graph of the operation for the change order selected is displayed. FIG. 5 illustrates the RCA graph associated with a change order #125. The RCA graph provides a snapshot of the configuration items associated with the operation. The configuration items affected by the change order are highlighted. In the example provided in FIG. 5, logs management 400 and LDAP server 404 are the configuration items that were affected by the selected change order. The change order selected did not add or remove configuration items associated with the failed operation. The RCA graph for each of the change orders has a potential cause area 500 that lists the highlighted configuration items and a calculated percentage for each listed configuration item that the configuration item is the root cause of failure of the operation. FIG. 6 illustrates a RCA graph for a change order that removed the logs management configuration item 400 and the LDAP server configuration item 404 and added access controller 600 to the RCA graph for the change order that was selected. For this change order, the configuration items affected by the change order are the access control service 412, the wireless router 414, and the access controller 600.

Turning to FIG. 8, at operation 800, the calculated percentage for each of the configuration items in the list is based on whether the change order is classified as a major incident, whether the change order is classified as an unauthorized change order, whether the change order is classified as an emergency order, whether any attribute of the configuration item has been changed, whether any of the configuration items being displayed has been added, whether any configuration item was removed, and a focal distance the configuration item is from a focal configuration item. In the RCA graph of FIGS. 4-7, the focal configuration item is the access control service 412. The focal distance is the number of configuration items a configuration item is away from the focal configuration item. In FIG. 5, for example, the logs management configuration item 400 has a focal distance of 2 and the LDAP server configuration item has a focal distance of three.

Turning to FIG. 9, in one embodiment, the calculated percentage is calculated by first determining Pcalc in operation 900 for each listed configuration item where

$$Pcalc = ( {W}_{1} \cdot MI ) + ( {W}_{2} \cdot UC ) + ( {W}_{3} \cdot EM ) + ( {W}_{4} \cdot AC ) + ( {W}_{5} + AD ) + ( {W}_{6} \cdot De ) + ( {W}_{7} \cdot \frac{1}{DI ( n )} ) .$$

W₁-W₇ are user configurable weights, MI is a number of major incidents reported for the change order between the change order number displayed and the current state and is 0 if there are no major incidents, UC is 1 if the change order is classified as an unauthorized change order and 0 if the change order is not classified as a an unauthorized change order, EM is 1 if the change order is classified as an emergency change and 0 if the change order is not classified as an emergency change, AC is 1 if any attribute of the configuration item has been changed and 0 if no attributes of the configuration item has been changed, AD is 1 if a configuration item has been added and 0 if a configuration item has not been added, DE is 1 if any configuration item was removed and 0 if no configuration item was remove, and DI a focal distance the configuration item is from a focal configuration item. For example, in one embodiment, the weights W₁ to W₇ may be W₁=30, W₂₌10, W₃=30, W₄=2, W₅=10, W₆=10, and W₇=9. The Pcalc calculation with these weights is

$$Pcalc = ( 30 \cdot MI ) + ( 10 \cdot UC ) + ( 30 \cdot EM ) + ( 2 \cdot AC ) + ( 10 + AD ) + ( 10 \cdot De ) + ( 9 \cdot \frac{1}{DI ( n )} ) .$$

Other weightings can be used. In operation 902, the Pcalc for each configuration item in the list is calculated and normalized using the sum of all Pcalc calculated for the configuration items in the list.

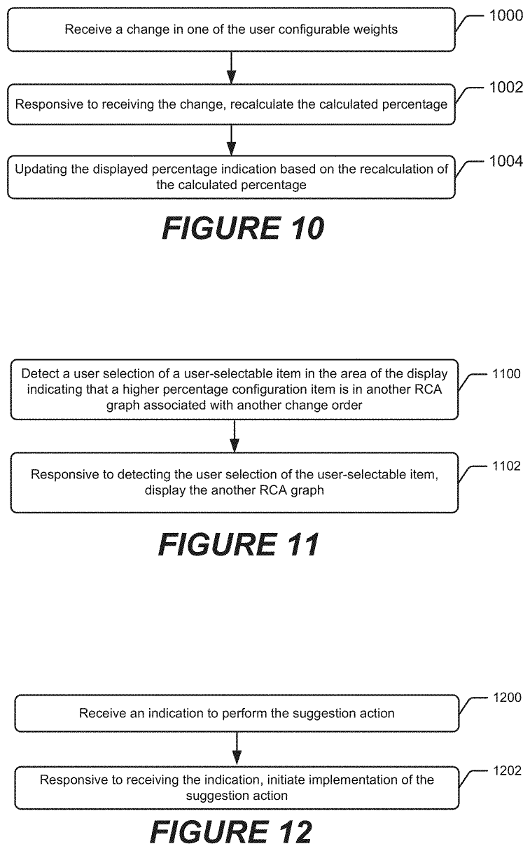

A user may want to change the weightings. Turning to FIG. 10, the change management engine 104 receives a change in one or more of the user configurable weights at operation 1000. At operation 1002, responsive to receiving the change, the calculated percentages for each of the configuration items listed as a potential cause in the RCA graph is recalculated. At operation 1004, the displayed percentage indication is updated based on the recalculation of the calculated percentage.

Returning to FIG. 2B, at operation 222, a determination is made as to whether the highest percentage configuration item of configuration items affected by all change orders from the baseline state to the current state is associated with the selected change order. For example, the change management engine 104 determines which change order has the highest percentage configuration item by comparing the normalized Pcalc for each configuration item that is affected by the change orders. At operation 224, if the highest percentage configuration item is not associated with the selected change order, an indication is displayed that indicates a higher percentage calculation for a configuration item affected by another change order exists.

FIGS. 5 and 6 illustrate an indication 502 that a higher percentage potential cause exists. The indication 502 in an embodiment has a user selectable item 504. Turning to FIG. 11, at operation 1100, the configuration change engine 104 detects a user selection of the user selectable item 504 in the area of the display having the indication 502 that a percentage configuration item having a highest percentage is in another RCA graph associated with another change order. At step 1102, responsive to detecting the user selection of the user-selectable item, the RCA graph with the configuration item having the highest percentage is displayed.

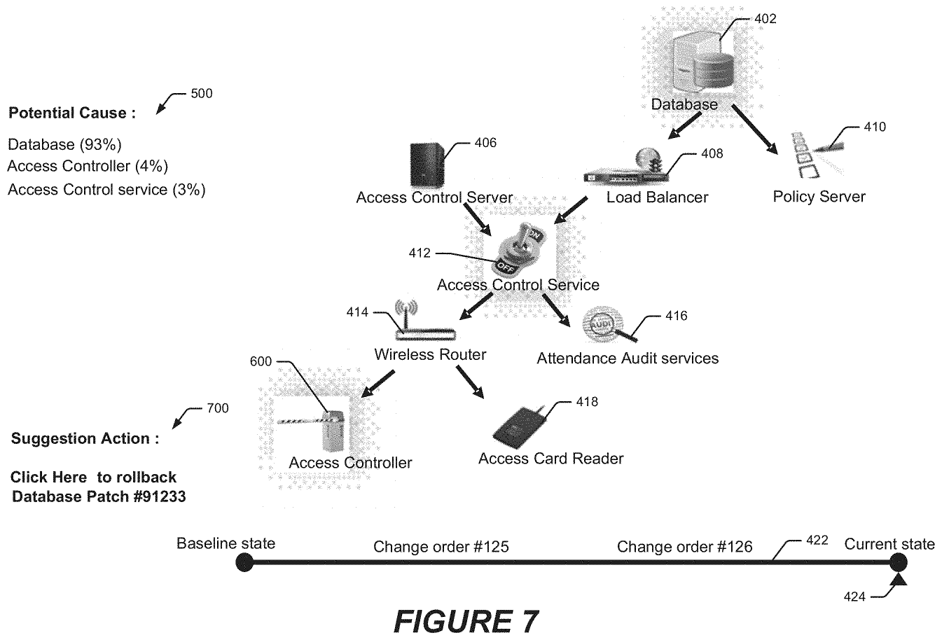

Returning to FIG. 2B, at operation 226, when the RCA graph having a configuration item that has the highest percentage is displayed, a suggestion action is displayed in the RCA graph when the highest percentage is above a threshold. For example, in one embodiment, if the highest percentage of a configuration item is above 90%, the suggestion action is displayed. FIG. 7 provides an example of a change order having a configuration item having the highest percentage. Specifically, the database configuration item has a calculated percentage of 93%. Suggestion action 700 is displayed when the calculated percentage is above the threshold. In some situations, more than one configuration item may have a calculated percentage that is above the threshold. For example, if the threshold is a relatively low threshold, multiple configuration items that are displayed as a potential cause in different change orders may have a calculated percentage above the threshold. In such situations, there may be a suggestion action displayed on multiple RCA graphs.

The suggestion action 700 has a user-selectable item. Turning to FIG. 12, the change management engine 104 receives an indication to perform the suggestion action at operation 1200. For example, the change management engine 104 may detect a user selection of the user-selectable item. In other embodiments, the change management engine 104 may receive the indication from the CMDB 102 or another entity such as a root cause analysis engine of the computer system serviced by the CMDB 102. Response to receiving the indication, the change management engine 104 initiates implementation of the suggestion action at operation 1202.

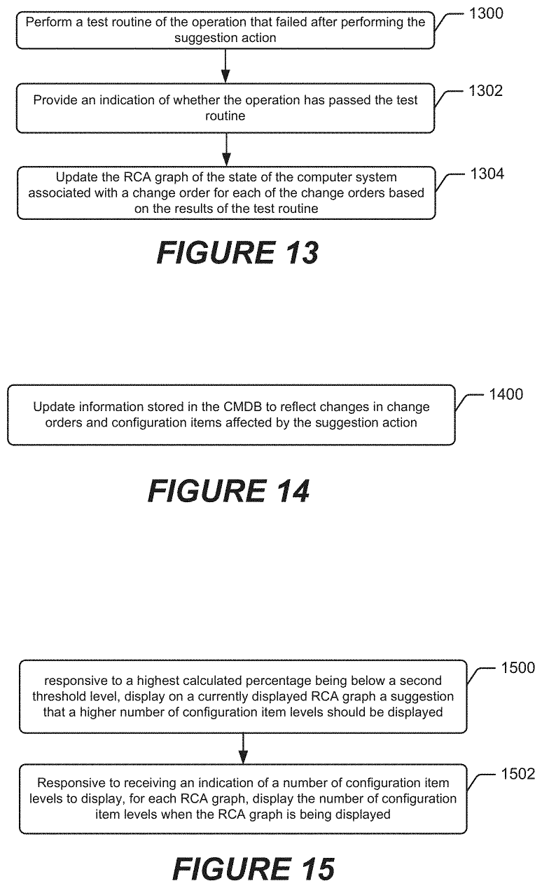

Turning now to FIG. 13, in an embodiment, the change management engine 104 or the CMDB 102 may perform a test routine of the operation that failed after performing the suggestion action at operation 1300. The change management engine 104 may provide an indication of whether the operation that failed has passed the test routine at operation 1302. The change management engine 104 or the CMDB 102 updates the RCA graph of the state of the computer system (e.g., the RCA graph of the operation) associated with a change order for each of the change orders associated with the operation based on the results of the test routine at operation 1304. Turning to FIG. 14, the CMDB 102 at operation 1400 also updates information stored by the CMDB 102 to reflect changes in the change order(s) and configuration item(s) affected by the suggestion action to reflect the changes that occurred with the performance of the suggestion action. The updating may include creating a new change order in the CMDB 102.

Turning now to FIG. 15, there can be scenarios where the calculated percentages of the displayed configuration items associated with the operation that failed are all below a threshold level. At operation 1500, responsive to a highest calculated percentage being below a second threshold level, a suggestion is displayed on the displayed RCA graph that a higher number of configuration levels should be displayed. For example, the RCA graphs illustrated in FIGS. 4-7 have five configuration levels. More configuration levels may be displayed that illustrate additional configuration items associated with the operation that failed. The user may select or enter a number of configuration item levels to display. At operation 1502, responsive to receiving an indication of a number of configuration items to display, for each RCA graph, display the number of configuration item levels when the RCA graph is displayed. For example, if ten configuration item levels are selected, then ten configuration item levels are displayed when there are at least ten configuration item levels associated with the operation that failed. If there are less configuration item levels associated with the operation that failed than the number selected, then all of the configuration item levels associated with the operation that failed are displayed. For example, if there are only seven levels of configuration items for an operation and ten configuration item levels are selected to be displayed, then the seven levels of configuration items for the operation are displayed.

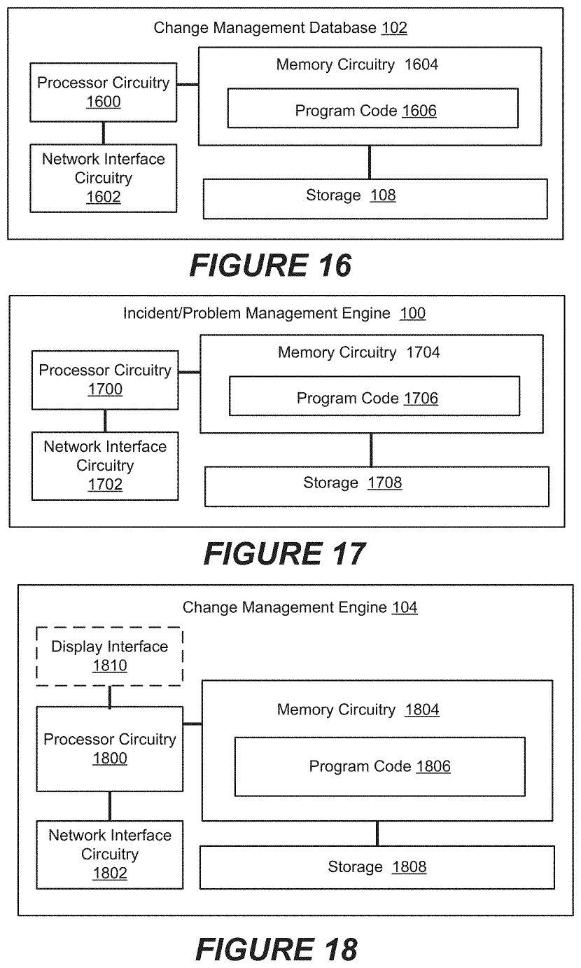

Turning now to FIG. 16, an overview diagram of a suitable computer hardware and computing environment in conjunction with which various embodiments of the change management database 102 may be practiced is illustrated. The description of FIG. 16 is intended to provide a brief, general description in conjunction with which the subject matter described herein may be implemented to provide the change order storage, update, and identification and provide the information to create the RCA graphs. In some embodiments, the subject matter is described in the general context of computer-executable instructions, such as program modules, being executed by a computer, such as a personal computer that provide the improvements described above. Generally, program modules include routines, programs, objects, components, data structures, and the like, that perform particular functions described above. Moreover, those skilled in the art will appreciate that the subject matter may be practiced with other computer system configurations, including hand-held devices, multiprocessor systems, microprocessor-based or programmable consumer electronics, network PCs, minicomputers, mainframe computers, and the like. As used herein, a “processor” includes one or more processors, microprocessors, computers, co-processors, graphics processors, digital signal processors, arithmetic logic units, system-on-chip processors, etc. The subject matter may also be practiced in distributed computer environments where tasks are performed by I/O remote processing devices that are linked through a communications network. In a distributed computing environment, program modules may be located in both local and remote memory storage devices.

In the embodiment shown in FIG. 16, a hardware and operating environment is provided that is applicable to the change management database 102 shown in the other figures. As shown in FIG. 16, one embodiment of the hardware and operating environment includes processing circuitry 1600 having one or more processing units coupled to the network interface circuitry 1602 and a memory circuitry 1604. The memory circuitry 1604 may include a ROM, e.g., a flash ROM, a RAM, e.g., a DRAM or SRAM, or the like and includes suitably configured program code 1606 to be executed by the processing circuitry so as to implement the above described functionalities of the change management engine database 102. The storage 108 may include a mass storage, e.g., a hard disk or solid-state disk, or the like. There may be only one or more than one processing unit, such that the processor circuitry 1600 comprises a single central-processing unit (CPU), or a plurality of processing units, commonly referred to as a multiprocessor or parallel-processor environment. A multiprocessor system can include cloud computing environments.

FIG. 17 provides an overview diagram of a suitable computer hardware and computing environment in conjunction with which various embodiments of the incident/problem management engine 100 may be practiced. The description of FIG. 17 is intended to provide a brief, general description in conjunction with which the subject matter described herein may be implemented to provide the indication of failed operations. In some embodiments, the subject matter is described in the general context of computer-executable instructions, such as program modules, being executed by a computer, such as a personal computer that provide the improvements described above. Generally, program modules include routines, programs, objects, components, data structures, and the like, that perform particular functions described above. Moreover, those skilled in the art will appreciate that the subject matter may be practiced with other computer system configurations, including hand-held devices, multiprocessor systems, microprocessor-based or programmable consumer electronics, network PCs, minicomputers, mainframe computers, and the like. As used herein, a “processor” includes one or more processors, microprocessors, computers, co-processors, graphics processors, digital signal processors, arithmetic logic units, system-on-chip processors, etc. The subject matter may also be practiced in distributed computer environments where tasks are performed by I/O remote processing devices that are linked through a communications network. In a distributed computing environment, program modules may be located in both local and remote memory storage devices.

In the embodiment shown in FIG. 17, a hardware and operating environment is provided that is applicable to the incident/problem management engine 100 shown in the other figures. As shown in FIG. 17, one embodiment of the hardware and operating environment includes processing circuitry 1700 having one or more processing units coupled to the network interface circuitry 1702 and a memory circuitry 1704. The memory circuitry 1704 may include a ROM, e.g., a flash ROM, a RAM, e.g., a DRAM or SRAM, or the like and includes suitably configured program code 1706 to be executed by the processing circuitry so as to implement the above described functionalities of the incident/problem management engine 100. The storage 1708 may include a mass storage, e.g., a hard disk or solid-state disk, or the like. There may be only one or more than one processing unit, such that the processor circuitry 1700 comprises a single central-processing unit (CPU), or a plurality of processing units, commonly referred to as a multiprocessor or parallel-processor environment. A multiprocessor system can include cloud computing environments.

FIG. 18 provides an overview diagram of a suitable computer hardware and computing environment in conjunction with which various embodiments of change management engine 104 may be practiced. The description of FIG. 18 is intended to provide a brief, general description in conjunction with which the subject matter described herein may be implemented that provides improvements in determining root causes of failure. In some embodiments, the subject matter is described in the general context of computer-executable instructions, such as program modules, being executed by a computer, such as a personal computer that executes the improvements described herein. Generally, program modules include routines, programs, objects, components, data structures, and the like, that perform particular tasks or implement particular abstract data types.

In the embodiment shown in FIG. 18, a hardware and operating environment is provided that is applicable to the change management engine 104 described in the other figures and described above. Moreover, those skilled in the art will appreciate that the subject matter may be practiced with other computer system configurations, including hand-held devices, multiprocessor systems, microprocessor-based or programmable consumer electronics, network PCs, minicomputers, mainframe computers, and the like. As used herein, a “processor” includes one or more processors, microprocessors, computers, co-processors, graphics processors, digital signal processors, arithmetic logic units, system-on-chip processors, etc. The subject matter may also be practiced in distributed computer environments where tasks are performed by I/O remote processing devices that are linked through a communications network. In a distributed computing environment, program modules may be located in both local and remote memory storage devices.

In the embodiment shown in FIG. 18, a hardware and operating environment is provided that is applicable to the change management engine 104 shown in the other figures. As shown in FIG. 18, one embodiment of the hardware and operating environment includes processing circuitry 1800 having one or more processing units coupled to the network interface circuitry 1802 and a memory circuitry 1804. The memory circuitry 1804 may include a ROM, e.g., a flash ROM, a RAM, e.g., a DRAM or SRAM, or the like and includes suitably configured program code 1804 to be executed by the processing circuitry so as to implement the above described functionalities of the change management engine 104. The storage 1808 may include a mass storage, e.g., a hard disk or solid-state disk, or the like. There may be only one or more than one processing unit, such that the processor circuitry 1800 of change management engine 104 comprises a single central-processing unit (CPU), or a plurality of processing units, commonly referred to as a multiprocessor or parallel-processor environment. A multiprocessor system can include cloud computing environments. The change management engine 104 may have a display interface 1810 that the change management engine 104 uses to interface with displays used to display the RCA graphs as described herein.

Thus, example systems, methods, and non-transitory machine readable media for reducing occurrences have been described. The advantages provided include reducing occurrence of errors in determining a root cause of failure of an operation, reducing load on the networks used by displaying changes made by a change order and a percentage indication that the configuration items changed are the root cause of failure, providing an indication that a higher percentage possible root cause of failure is in another RCA graph of another change order and a link to that RCA graph. The advantages result in faster identification of a root cause of a failure of a failed operation of a computer system.

As will be appreciated by one of skill in the art, the present inventive concepts may be embodied as a method, data processing system, or computer program product. Furthermore, the present inventive concepts may take the form of a computer program product on a tangible computer usable storage medium having computer program code embodied in the medium that can be executed by a computer. Any suitable tangible computer readable medium may be utilized including hard disks, CD ROMs, optical storage devices, or magnetic storage devices.

Some embodiments are described herein with reference to flowchart illustrations or block diagrams of methods, systems and computer program products. It will be understood that each block of the flowchart illustrations or block diagrams, and combinations of blocks in the flowchart illustrations or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer readable memory that can direct a computer or other programmable data processing apparatus to function in a particular manner, such that the instructions stored in the computer readable memory produce an article of manufacture including instruction means which implement the function/act specified in the flowchart or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations described herein may be written in an object-oriented programming language such as Java® or C++. However, the computer program code for carrying out operations described herein may also be written in conventional procedural programming languages, such as the “C” programming language. The program code may execute entirely on the user's computer, partly on the user's computer, as a standalone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way or combination, and the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed typical embodiments and, although specific terms are employed, they are used in a generic and descriptive sense only and not for purposes of limitation, the scope of the inventive concepts being set forth in the following claims.

What is claimed is:

1. A method by a computer of a computing system, the method comprising:
receiving an indication of an operation that failed in a computer system associated with the operation;
determining, starting at a baseline state of the operation and ending at a current state of the operation, a number of change orders that change one or more configuration items that are associated with the operation;
displaying a baseline state root cause analysis (RCA) graph, the baseline state RCA graph representing a last known state of the operation where the operation passed testing, the baseline state RCA graph comprising a plurality of configuration items and connections between the plurality of configuration items in a first area of a display and a change order timeline in a second area of the display;
for each of the number of change orders and responsive to receiving a user selection of a change order in the change order timeline, displaying a RCA graph of a state of the computer system associated with the operation, wherein the RCA graph of the state of the computer system associated with the operation comprises:
a number of the plurality of configuration items that remain associated with the operation and connections between the number of the plurality of configuration items displayed in the first area , wherein any of the number of the plurality of configuration items that remain that were changed by the change order are highlighted;
an indication of the change order displayed in the change order timeline; and
a potential cause listing in a third area of the display, wherein the potential cause listing displays a list of configuration items that are highlighted and a percentage indication by each configuration item in the list of configuration items, each percentage indication representing a calculated percentage that the configuration item is a potential cause of the failure.

2. The method of claim 1 further comprising displaying a number of new configuration items added by the change order in the first area and connections between the number of new configuration items and the number of the plurality of configuration items displayed in the first area and highlighting any of the number of new configuration items that were changed by the change order.

3. The method of claim 1 wherein the RCA graph of the state of the computer system associated with the operation further comprises a suggestion action displayed in a fourth area of the display responsive to a percentage indication of a configuration item listed in the third area of the display being above a first threshold level.

4. The method of claim 3 further comprising:
responsive to receiving an indication to perform the suggestion action, initiating performance of the suggestion action.

5. The method of claim 4, further comprising:
performing a test routine of the operation that failed after performing the suggestion action; and
providing an indication of whether the operation passed the test routine.

6. The method of claim 5, further comprising:
updating the RCA graph of the state of the computer system associated with the change order for each of the change orders based on results of the test routine.

7. The method of claim 1 further comprising calculating the calculated percentage for each configuration item in the list using a user configurable weighted calculation based on whether the change order is classified as a major incident, whether the change order is classified as an unauthorized change order, whether the change order is classified as an emergency order, whether any attribute of the configuration item has been changed, whether any of the configuration items being displayed has been added, whether any configuration item was removed, and a focal distance the configuration item is from a focal configuration item.

8. The method of claim 7 wherein calculating the calculated percentage comprises:
determining
$$Pcalc = ( {W}_{1} \cdot MI ) + ( {W}_{2} \cdot UC ) + ( {W}_{3} \cdot EM ) + ( {W}_{4} \cdot AC ) + ( {W}_{5} + AD ) + ( {W}_{6} \cdot De ) + ( {W}_{7} \cdot \frac{1}{DI ( n )} )$$
for each configuration item in the list; and
normalizing Pcalc using the sum of all Pcalc determined,
wherein W₁-W₇ are user configurable weights, MI is a number of major incidents reported for the change order between the change order number displayed and the current state and is 0 if there are no major incidents, UC is 1 if the change order is classified as an unauthorized change order and 0 if the change order is not classified as a an unauthorized change order, EM is 1 if the change order is classified as an emergency change and 0 if the change order is not classified as an emergency change, AC is 1 if any attribute of the configuration item has been changed and 0 if no attributes of the configuration item has been changed, AD is 1 if a configuration item has been added and 0 if a configuration item has not been added, DE is 1 if any configuration item was removed and 0 if no configuration item was remove, and DI a focal distance the configuration item is from a focal configuration item.

9. The method of claim 8 further comprising:
receiving a change in one of the user configurable weights;
responsive to receiving the change in the one of the user configurable weights, recalculating the calculated percentage; and
updating the displayed percentage indication based on the recalculating of the calculated percentage.

10. The method of claim 1 wherein the RCA graph of the state of the computer system associated with the operation further comprises an indication displayed in a fifth area of the display indicating that a higher percentage configuration item is in another RCA graph associated with another change order.

11. The method of claim 1 wherein each of the RCA graphs of a state of the computer system associated with the operation is displayed with a default number of configuration item levels, the method comprising:
responsive to a highest calculated percentage being below a second threshold level, displaying on a currently displayed RCA graph a suggestion that a higher number of configuration item levels should be displayed; and
responsive to receiving an indication of a number of configuration item levels to display, for each RCA graph, displaying the number of configuration item levels when the RCA graph is being displayed.

12. A configuration management system configured to recommend potential root causes of failure of an operation of a computer system, the configuration management system comprising:
an incident problem management engine configured to receive a message indicating an operation that failed in the computer system;
a configuration management database (CMDB) configured to:
receive and store change orders;
store associations of configuration items with change orders and operations of computer systems; and
store information regarding a baseline state for a plurality of operations performed by the computer system, each baseline state representing a last known state of an operation of the plurality of operations in which the operation passed testing, the information for each baseline state comprising a listing of a plurality of configuration items and connections between the plurality of configuration items; and
a change management engine configured to:
responsive to receiving an indication of the message indicating the operation that failed, fetch information from the CMDB regarding a baseline state for the operation that failed;
identify, from the CMDB and starting at a baseline state of the operation and ending at a current state of the operation, a number of change orders that change one or more configuration items that are associated with the operation;
for each of the number of change orders, fetching information from the CMDB regarding configuration items changed by the change order;
display a baseline state root cause analysis (RCA) graph in a first area of a display and a change order timeline in a second area of the display;
responsive to receiving a user selection of a change order in the timeline, display a RCA graph of a state of the computer system associated with the operation, wherein the RCA graph of the state of the computer system associated with the operation comprises:
a number of the plurality of configuration items that remain associated with the operation and connections between the number of the plurality of configuration items displayed in the first area, wherein any of the number of the plurality of configuration items that remain that were changed by the change order are highlighted;
a number of new configuration items when the change order indicates new configuration items have been added and connections between the number of new configuration items and the number of the plurality of configuration items displayed in the first area, wherein any of the number of new configuration items that were added by the change order are highlighted;
an indication of the change order displayed in the change order timeline; and
a potential cause listing in a third area of the display, wherein the potential cause listing displays a list of configuration items that are highlighted and a percentage indication by each configuration item in the list of configuration items, each percentage indication representing a calculated percentage that the configuration item is a potential cause of the failure.

13. The configuration management system of claim 12, wherein the CMDB is further configured to:
receive a new change order;
parse the change order to determine configuration items changed by the new change order and to determine configuration items added or deleted from the computer system; and
store information regarding the configuration items changed by the new change order and information regarding the configuration items added or deleted from the computer system.

14. The configuration management system of claim 12, wherein the change management engine is further configured to:
identify when a percentage indication of a configuration item in the list of configuration items is above a first threshold; and
display a suggestion action in a fourth area of the display responsive to the percentage indication being above the first threshold.

15. The configuration management system of claim 14, wherein the suggestion action comprises a user-selectable icon and wherein the configuration management engine is further configured to:
detect a user selection of the user-selectable icon; and
responsive to detecting the user selection, initiating implementation of the suggestion action.

16. The configuration management system of claim 12 wherein the configuration management engine is further configured to calculate the calculated percentage for each configuration item changed by a change order by:
determining
$$Pcalc = ( {W}_{1} \cdot MI ) + ( {W}_{2} \cdot UC ) + ( {W}_{3} \cdot EM ) + ( {W}_{4} \cdot AC ) + ( {W}_{5} + AD ) + ( {W}_{6} \cdot De ) + ( {W}_{7} \cdot \frac{1}{DI ( n )} )$$
for each configuration item in the list of configuration items; and
normalizing Pcalc using the sum of all Pcalc determined,
wherein W₁-W₇ are user configurable weights, MI is 1 if the change order is classified as a major incident and 0 if the change order is not classified as a major incident; UC is 1 if the change order is classified as an unauthorized change order and 0 if the change order is not classified as a an unauthorized change order, EM is 1 if the change order is classified as an emergency change and 0 if the change order is not classified as an emergency change, AC is 1 if any attribute of the configuration item has been changed and 0 if no attributes of the configuration item has been changed, AD is 1 if a configuration item has been added and 0 if a configuration item has not been added, DE is 1 if any configuration item was removed and 0 if no configuration item was remove, and DI a distance the configuration item is from a focal configuration item.

17. The configuration management system of claim 16 wherein the configuration management engine is further configured to:
receive a change in one of the user configurable weights;
responsive to receiving the change in the one of the user configurable weights, recalculate the calculated percentage; and
update the displayed percentage indication based on the recalculating of the calculated percentage.

18. The configuration management system of claim 12 wherein the configuration management engine is further configured to display an indication in a fifth area of the display indicating that a higher percentage configuration item is in another RCA graph associated with another change order.

19. The configuration management system of claim 18 wherein the indication in the fifth area of the display comprises a user-selectable icon, wherein the configuration management engine is further configured to display the another RCA graph responsive to detecting a user selection of the user-selectable icon.

20. The configuration management system of claim 12 wherein each of the RCA graphs of a state of the computer system is displayed with a default number of configuration item levels, wherein the configuration management engine is further configured to:
responsive to a highest calculated percentage being below a second threshold level, display on a currently displayed RCA graph a suggestion that a higher number of configuration item levels should be displayed; and
responsive to receiving an indication of a number of configuration item levels to display, for each RCA graph, displaying the number of configuration item levels in the RCA graph being displayed.
